(19) United States
(12) Patent Application Publication
(10) Pub. No.: US 2022/0228327 A1
(43) Pub. Date: Jul. 21, 2022

(54) BLOCK WITH ARTIFICIAL GRASS TO GRASS PAVEMENT STONES

(71) Applicants: Imre ERDÉLYI, Kerepes (HU); Sándor ERDÉLYI, Kerepes (HU); András ERDÉLYI, Kerepes (HU)

(72) Inventors: Imre ERDÉLYI, Kerepes (HU); Sándor ERDÉLYI, Kerepes (HU); András ERDÉLYI, Kerepes (HU)

(21) Appl. No.: 17/607,455

(22) PCT Filed: May 28, 2020
(86) PCT No.: PCT/HU2020/050018

§ 371 Date: Oct. 29, 2021

(30) Foreign Application Priority Data
May 31, 2019 (HU) P1900191

(51) Int. Cl. E01C 13/08; F16B 2/04

(52) U.S. Cl. CPC E01C 13/08; F16B 2/04

(57) ABSTRACT

The present invention is an artificial grass block that can accommodate to the different sized cells of the similar grass pavement stones produced by different companies. The artificial grass block can bear an up to 10% size difference of the cells. The artificial grass block can carry out this function by its elastic, flexible positioning-fixing unit, which positions and fixes the artificial grass block inside the cell of a certain size range. The positioning-fixing unit is longer than the cell before insertion and deforms during insertion. This deformed positioning-fixing unit creates a tension that appropriately positions and firmly fixes the artificial grass block within the cell. EOIC 5/20 Pavings made of prefabricated single units; made of units of plastics; EOIC 9/225 Pavings specially adapted for allowing vegetation; EOIC 11/225 Paving specially adapted for through-the-surfacing drainage, e.g. perforated, porous; Preformed paving elements comprising, or adapted to form, passageways for carrying off drainage; E03F 11/00 Water supply; sewerage; Sewers; Cesspools; E04F 13/24 Finishing work on buildings; Coverings or linings, Hidden fastening means on the rear of the covering or lining elements; F16B 2/00 Friction-grip releasable fastenings; F16F 1/36 Springs, made of plastics.

### TECHNICAL FIELD

E01C 5/20 Pavings made of prefabricated single units; made of units of plastics

E01C 9/225 Pavings specially adapted for allowing vegetation

E01C 11/225 Paving specially adapted for through-the-surfacing drainage, e.g. perforated, porous; Preformed paving elements comprising, or adapted to form, passageways for carrying off drainage

E03F 11/00 Water supply; sewerage; Sewers; Cesspools;

E04F 13/24 Finishing work on buildings; Coverings or linings, Hidden fastening means on the rear of the covering or lining elements

F16B 2/00 Friction-grip releasable fastenings

F16F 1/36 Springs, made of plastics;

The present invention is a block with a positioning-fixing unit and artificial grass that is used together with outdoor grass pavement stones by inserting the blocks into the cells of the grass pavement stones, where the positioning-fixing unit adjusts to the inner sizes of the cells.

### BACKGROUND

Grass pavement stones made of concrete are widely used as pavements where low velocity vehicle traffic can occur, for example at parkways. There are further terms used for grass pavement stones: grass pavements, grass grids, lawn grids, turf grids, grass pavers, turf pavers, and others. Throughout the descriptions of the invention, the term ‘grass pavement stone’ is used.

The grass pavement stone is not a part of the present invention, although it is necessary to include a description about it in order to ease the understanding of the invention.

The grass pavement stone is an outdoor building material for creating paved surfaces. Viewed from the top, one can observe a grid structure of the grass pavement stones, where the solid parts are made of load resistant materials, like concrete. The gap-like parts, which are open from the top and the bottom when the pavement stone is not laid on the ground, and, consequently, is closed from the bottom when laid on the ground are called cells.

Cells can either be inside a single grass pavement stone, between two or more neighboring grass pavement stones or between one grass pavement stone and any surface bordering installation. Cells are most frequently filled with substrate and planted with grass seeds, however there are other filling techniques too.

The German gentleman, Dieter Dobsch submitted a patent about blocks with artificial grass for the first time. In order to differentiate between the block described by Dieter Dobsch from the block of the present invention, the block of Dieter Dobsch will be termed ‘cube’ later on.

In his patent, Dieter Dobsch describes a cube with the size that fits the cells of the grass pavement stones. A cut-out artificial grass piece with identical sizes to the cube's upper surface is adhered onto the upper surface of this cube. In order to let the rainwater leak into the ground beneath the grass pavement stone, draining channels were created. Prepared cubes were then inserted into the cells of the grass pavement stones.

But what was the reason that the invention of Dieter Dobsch never made it to the market?

There are two requirements, where at least one of them must be met with in order for the cube, presented by Dieter Dobsch, to function as it was proposed. 1) The cells of the grass pavements have to be precisely identical even in between two neighboring pavement stones, regardless of the manufacturer of the grass pavement stone product. In such case, the cubes could be inserted into the cells without any problems. 2) Different types of cubes are manufactured with diverse parameters so that they would fit into all grass pavement stones manufactured, and the cubes can be further shaped, if necessary, to the appropriate form on site of the installation. In such case, the most suitable cube can always be selected for the forthcoming cell during installation.

These requirements are either never met with or would be very hard and costly to execute, respectively.

Even though outdoor pavement manufacturers create highly similar products of grass pavement stones, the cell sizes of these products are hardly ever the same. It is not unusual to observe a 5 mm or even larger difference between the cells of two similar grass pavements manufactured by different companies. Furthermore, some manufacturers design perfectly vertical walls for the cells, whereas others may tilt the wall with a few degrees, narrowing it towards the bottom of the cell. It is easy to understand that a cube that fits the top opening of a cell and tightens near the bottom is not suitable to create paved surfaces.

Even if all outdoor pavement manufacturers were producing perfectly identical grass pavement stones it is a challenging task to place the stones next to each other so perfectly that the cells created in between them are also identical to the ones inside the grass pavement stone. There can easily be a few millimeters of difference in two consecutive rows of grass pavement stones, which difference is hardly visible to the naked eye, but enough to deform the resulting cells. The cubes manufactured to a precisely defined size will not be able to fit into these deformed cells. This situation is even more highlighted when the grass pavement stones are placed along an arc. The resulting cells in between two or more grass pavement stones are even more deformed in such cases further inhibiting the insertion of the cubes.

These small differences in the cell sizes have the consequence that a cube with a given size is only suitable for the cells, many cases only the inner cells of a certain grass pavement stone of a certain manufacturer. If attempted to insert this particular cube into another grass pavement stone from another manufacturer that has, for example a few millimeters larger cells, then the imperfect fitting will cause wobbling, moving, turning of the cube, also it will be simpler to remove illegally the cube from the cell, or perhaps the cube will be able to be replaced by an outer effect, creating hazardous situations.

In the opposite case, when the cubes would to be inserted into a grass pavement stone with smaller cells, then the cubes will be returned to the seller, as to reshape the larger cubes will not be a reasonable task. The result is the same if a cube with vertical walls are attempted to be inserted into the cells of a grass pavement stone, where the cells are tilted with a few degrees towards the bottom of the cell. These cubes will jam into the cell before reaching the bottom.

These examples show that the use of the cubes described by Dieter Dobsch are highly limited, as they are usable only to a certain type of grass pavement stone manufactured by a certain company. As their use, their market will be limited too, which will increase the price of the products to an unreasonable sum. If different product types are designed and created for the most reasonable types of grass pavement stones, their production will be costly as each design needs a separate mold.

The inventions below do not present solutions to blocks, which adjust to the different sizes of similar products manufactured by different companies either.

The invention of EP2762639A1 suggests a special concrete element, in which lowered cassette blocks are created. The cut-out artificial grass pieces are fixed. This is not made up of blocks, the artificial grass piece is placed during the production of the concrete element.

This solution does not require separate artificial grass units, which could be put into an empty cell, as there are not cells at all. This invention, therefore, is not adequate to be used together with grass pavement stones.

There are elements, which can be connected to one another and it is possible to place a coverage of wish, e.g. artificial grass onto its surface. The invention of WO 2008/039782 A2 shows such a pavement. Although, this is about connectable pavements, like the grass pavement stones, there are no cells, which could be filled with other pavement elements after installation.

### SUMMARY OF THE INVENTION

The present invention aims to overcome the problems of the artificial grass cube, described by Dieter Dobsch, with a prepared artificial grass block. The artificial grass block of the present invention has a shape that is able to accommodate to the shape of the cell of the grass pavement stone in a range of up to 10% of size. After inserting the artificial grass block into the empty cell of the grass pavement stone, the block is firmly fixed, regardless of the size of the cell, so much that there will be no removal, wobbling, moving, or turning.

The artificial grass block of the present invention consists of 3 main parts. 1) The artificial grass is on the top of the block, sitting fixed on a 2) scaffold. A 3) positioning-fixing unit is placed on the scaffold too. This positioning-fixing unit is able to show a flexible deformation that accommodates the artificial grass block to the size of the cell it is inserted into, and therefore positioning and fixing the artificial grass block. The positioning-fixing unit can have different designs; it is possible to use a variety of shapes and materials. An expedient design would be the use of a solid rubber hemisphere, a rubber profile, an elastic plastic circle, a steel or plastic leaf spring, or any other solution that shows similar functionality. A common property of these positioning-fixing unit designs is that that originally they overhang the horizontal cross-section diameter of the cell of the grass pavement stone, and being pressed or deformed to the horizontal cross-section diameter of the cell when being inserted inside it. This pressing, deforming force is then fixes and positions the artificial grass block within the cell of the grass pavement stone. This fixing means a removable/dissolvable bond, where the fixing force is created by the friction between the positioning-fixing unit and the concrete wall of the cell. The friction force is equal to the thrust force perpendicular to the wall of the cell times the coefficient of the friction. This friction force holds the artificial grass block inside the cell of the grass pavement stone.

This friction force can be increased by a wedge-like or harpoon-like design of the positioning-fixing unit. In such cases the middle of the wedge or harpoon points towards the bottom of the cell, its tips towards the opening of the cell. If these wedge-like or harpoon-like positioning-fixing units are made of flexible materials, then the positioning-fixing unit is tightened against the wall of the cell when the artificial grass block attempted to be removed. It works similar to the awn of some grass species, like wheat, when being rubbed in between our hands; it only moves to one direction, never the opposite direction.

A positioning-fixing unit made up of two wing-like leaf-springs, attached to the scaffold of the artificial grass block follow the same principle, if the wings overhang the horizontal cross section diameter of the cell before being inserted into it. After insertion the wings fold back positioning the artificial grass block to the middle of the cell. The wings also fix the artificial grass block, as it locks itself into the cell when attempted to be removed, since the back folded wings are tightened against the wall of the cell, responding with an increasing force against the wall to the increasing force applied for the removal. Other than the wing-like structure, rods, wires, tubes, corrugated tubes etc. can act the same way.

The positioning-fixing unit enables, due to its flexibility, that the functions of positioning and fixing can be maintained within a minimal and a maximal size range of the cell of the grass pavement stone, regardless of the outdoor pavement producing company.

The scaffold shall not always have a solid, brick-like structure, it can work properly with a slender frame structure too. In such cases, the artificial grass is adhered onto a holding plate that is supported with a load resistant frame from below. This frame stands on the foundation of the grass pavement stone. The positioning-fixing unit can be placed on the scaffold, or in case of the slender frame structure, on the holding plate or on the frame as well.

The concept of the artificial grass block of the present invention is applicable to any sized and shaped cell of any grass pavement stone, but for the ease of understanding, we present the operation of the artificial grass block on one of the most common grass pavement stones. It is must be stated that even though the operation of the artificial grass block is presented on one of the most common grass pavement stones termed here as conventional grass pavement stone the innovation must not be constrained only to the “conventional” grass pavement stones.

The conventional grass pavement stones are either 60×40 centimeters or 40×40 centimeters, in which cells with a horizontal cross-section shape of square with sides of about 9×9 centimeters are placed, diagonally, rotated with 45° compared to the extension of the stone. The pavement stone can most commonly have a height of 8 or 10 centimeters, but there might be others with different heights. The conventional grass pavement stones take up to an approximately 80% of all the grass pavement stones available on the market.

The grass pavement stones are laid on an appropriately prepared foundation. The cells are empty at this state. The artificial grass blocks of the present invention can be inserted into these empty cells.

If the cells of the grass pavement stones are filled earlier, the filling material (e.g. substrate or gravel) shall be partially or entirely removed, before the artificial grass blocks can be inserted. The amount of removal of the filling material can happen entirely, when the filling material is removed until the lower plain of the grass pavement stone where the original foundation would start, or partially, when the filling material is removed only until a certain depth e.g. until the half of the cell.

Further on, under the term ‘cell’, entirely or partially empty cells, according to the description above, those are open only from the top are meant. The bottom of the cell is termed ‘level of foundation’ regardless of what is its level in the cell and if it is made of the material used for the foundation.

An artificial grass block can be inserted into any cell of a conventional grass pavement stone only if it fits the smallest cell of a conventional grass pavement stone manufactured by a company. For example, if the horizontal cross-section geometry of the cells of the conventional grass pavement stones are square or a near square rectangle with the sizes ranging from 82×82 millimeters to 90×90 millimeters depending on the manufacturer of the grass pavement stone than the area of the artificial grass shall not exceed the 82×82 millimeters. If an artificial grass block with an artificial grass piece of 82×82 millimeters is inserted into a cell of 90×90 millimeters, 4 millimeters wide gaps appear on the sides of the artificial grass piece. This gap does not cause aesthetic problems as the threads of the artificial grass can sway as much as the gap becomes hidden.

The scaffold under the artificial grass holding plate can have different geometries, for example solid brick-like block, a framed support, or others.

The positioning-fixing unit shall be made of an elastic but resistant material. The size of the positioning-fixing unit is defined by the expected largest size of the cell it shall be inserted into, and by the direction it shall be inserted in the cell. If the positioning-fixing unit is perpendicular viewed from the top to the walls of a cell with a square shaped horizontal cross-section, then its length shall be at least 90 millimeters for the example above. If the positioning-fixing unit points towards one of the diagonals of the square shaped horizontal cross-section of the cell, then the length of the positioning-fixing unit can be calculated using the formula of Pythagoras, which is a minimum of approximately 130 millimeters in case of the example above. There can be other arrangements possible with other sizes.

The number of the positioning-fixing unit is at least one.

### SHORT DESCRIPTION OF THE FIGURES

FIG. 1: The built up of the artificial grass block

FIG. 2: The insertion of the artificial grass block

FIG. 3: The insertion of a shorter artificial grass block

FIG. 4: A circular shaped example for the positioning-fixing unit

### DETAILED DESCRIPTION OF THE INVENTION

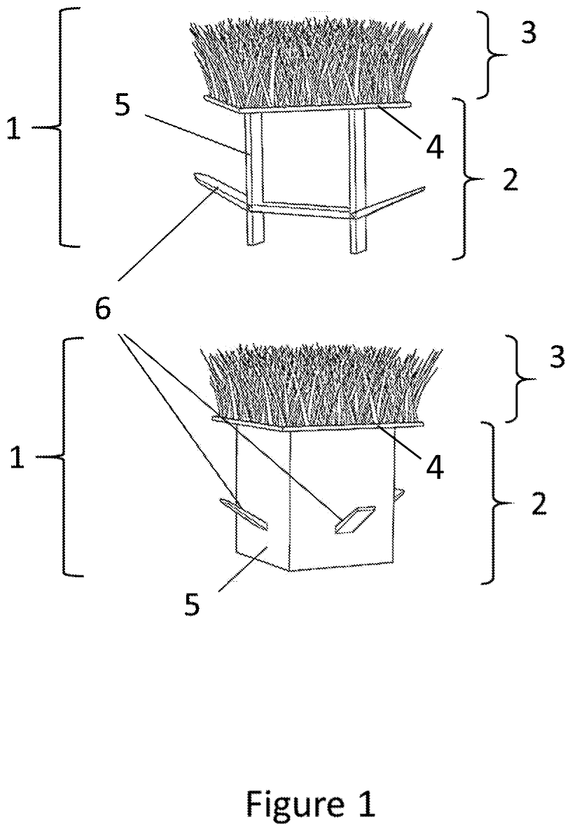

FIG. 1 shows two expedient designs of the invention and its main parts. The artificial grass block 1 consists of a scaffold 2 and an artificial grass 3 fixed onto it with, for instance gluing. The scaffold 2 has two parts, the holding plate 4 and the support 5, and the positioning-fixing unit 6 can be fixed to either of them. The two expedient designs of FIG. 1 differ on the implementation of the support 5. On the upper part of the figure, a slender frame is depicted, whereas on the lower part of the figure a solid brick-like structure is shown. The support 5 can have other designs too, those are not presented here, although those designs shall fall under the scope of the present invention if a positioning-fixing unit can be attached to them. On FIG. 1 the scaffold 2 and the positioning-fixing unit 6 are made of a single piece that can be produced with molding, injection molding, 3D printing, chipping, or any other appropriate technique.

The size of the holding plate 4 of the example shall be defined by considering the reasonably smallest of the cells 10 of the conventional grass pavement stones 9 produced by the different companies, which size should be larger than the size of the holding plate 4. In case of the conventional grass pavement stones 9 this reasonable size is about 82×82 millimeters. The holding plate 4 should not be larger the 82×82 millimeters, so that it is expectable that about the 95% of the conventional grass pavement stones will be compatible with the artificial grass block 1.

The height of the artificial grass block 1 depends on the height of the designated grass pavement stone 9. The usual height of the grass pavement stone 9 is 80 or 100 millimeters, although grass pavement stones 9 with other heights are also common. The height of the scaffold 2 can determine the final height of the artificial grass block 1, so that its height shall be chosen accordingly. Safety regulations maximize the acceptable height difference between two levels in an about 20-25 millimeters before it would cause the risk of stumble. This applies to the level difference between the upper surface of the grass pavement stone 9 and the origin of the artificial grass 3 threads. These safety regulations are in use in the time of the application of the present innovation, which might change over time due to different reasons.

If the grass pavement stones 9 are laid on a prepared flat foundation and the artificial grass block 1 is placed on this foundation within the cell 10 of the grass pavement stone 9, the minimal height of the scaffold 2 shall be minimum 55 millimeters if the grass pavement stone 9 is 80 millimeters high, and minimum 75 millimeters if the grass pavement stone 9 is 100 millimeters high, based on the safety regulations described above.

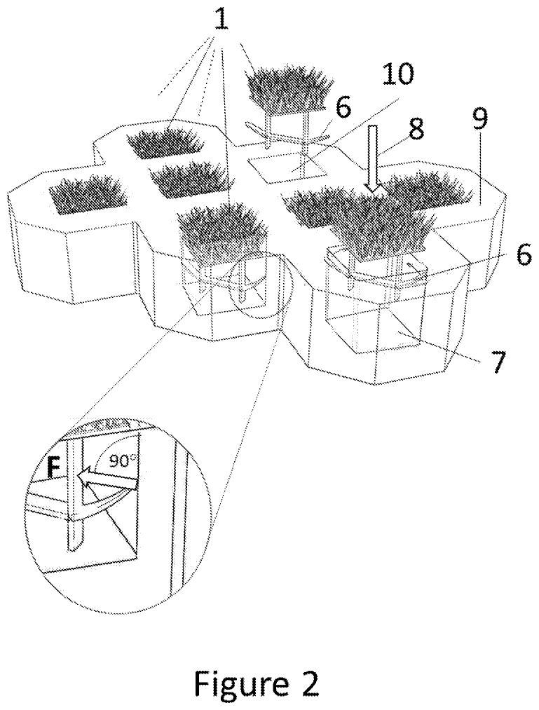

FIG. 2 shows the insertion of artificial grass blocks 1 into the cells 10 of the grass pavement stone 9 in this case, into the conventional grass pavement stone 9. The upper part of FIG. 2 depicts an entire grass pavement stone 9, whereas the lower part of FIG. 2 shows an enlarged part of the upper part of the FIG. 2 with an artificial grass block 1 inside a cell 10. The grass pavement stone 9 of the upper part of FIG. 2 is presented partially transparent, for a better understanding. In this example, the artificial grass block 1 shall be inserted in the cell 10 of the grass pavement stone 9 in the direction 8 indicated by the arrow, rotated so that the positioning-fixing unit 6 is diagonal to the cell 10 of the grass pavement stone 9. The artificial grass block 1 shall be inserted into the cell 10 of the grass pavement stone 9 by pressing the artificial grass block 1 along the direction of insertion 8, indicated by the arrow, as long as the artificial grass block 1 reaches the level of foundation 7 that is in level with the lower face of the grass pavement stone 9 in the bottom of the cell 10 of the grass pavement stone 9.

The wing-like positioning-fixing unit 6 bends upwards as the artificial grass block 1 is being inserted into the cell 10 of the grass pavement stone 9, as it can be seen on FIG. 2. On the enlarged part of FIG. 2, the force that affects the artificial grass block 1 within the cell 10 is marked with F and is perpendicular to the wall of the cell 10. This F force positions the artificial grass block 1 inside the cell 10. The tips of the wing-like positioning-fixing unit 6 are not perpendicular to the wall of the cell 10 but form acute angles with it. The tips of the wing-like positioning-fixing unit 6 point upwards when bent inside the cell 10. In case a force opposite to the direction of insertion 8, indicated with an arrow, applied to the artificial grass block 1, the tips of the bent positioning-fixing unit 6 stuck in the irregularities of the concrete surface 11 of the wall of the cell 10, due to its high friction coefficient. Also, this force opposite to the direction of insertion 8 would want the positioning-fixing unit 6 to bend the opposite direction inside the cell 10 downwards. This force presses the positioning-fixing unit 6 against the wall of the cell 10 with a proportional volume to the force opposite to the direction of insertion 8. The wing-like positioning-fixing unit 6 forwards all these forces to the scaffold 2 of the artificial grass block 1 that results a highly stabile state of the artificial grass block 1 within the cell 10 of the grass pavement stone 9.

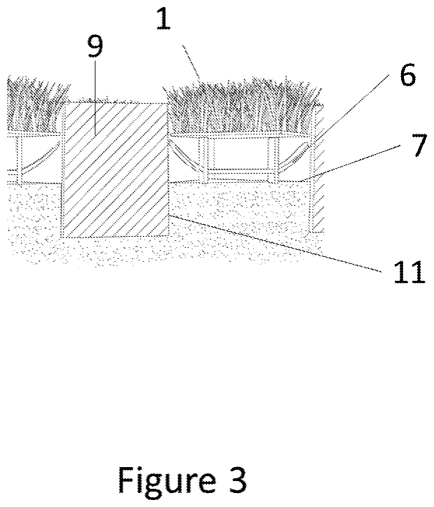

FIG. 3 shows another expedient design. When a grass pavement stone 9 shall be renewed, not all the filling material would be removed from the cells 10 but only a part, taking care that in the end all the cells 10 about the same amount of filling material should be left for aesthetic reasons. The level of foundation 7 inside the cell 10 is therefore higher than the lower face of the grass pavement stone 9. In such cases, the height of the scaffold 2 can even be shorter than the shortest sizes discussed earlier.

The bottom part of the support 5, which stands on the level of foundation 7 can have a smaller area of surface than that of the level of the foundation 7. The area of surface of the bottom part of the support 5 shall be defined taking into account that the artificial grass block 1 can be inserted into the cell 10 until the level of foundation 7 even if the walls of the cell 10 are tilted to some degree, and that the artificial grass block 1 should not sink inside the foundation if pressing force is applied onto the top of the artificial grass block 1.

The support 5 forwards the force between the holding plate 4 and the foundation at the bottom of the cell 10, applied to the artificial grass block 1. There are no limits to the design and to the materials used for the support 5. The support 5 might be an appropriate position where the positioning-fixing unit 6 is placed, although there are no constrains in placing the positioning-fixing unit 6 either. The positioning-fixing unit 6 can be placed on the holding plate 4, or other parts of the artificial grass block 1 too. The positioning-fixing unit 6 shall be flexible and strong enough to keep the artificial grass block 1 in its place.

On the upper image of FIG. 1 the positioning-fixing unit 6 is placed diagonally, whereas on the lower image, there are one positioning-fixing unit 6 for every vertical side of the scaffold 2. These positioning-fixing units 6 are depicted as wing-like structures here, although other forms may be used as well. The positioning-fixing units 6 can be placed in the diagonals, perpendicular to the sides, or other ways of the vertical cross-section geometry of the cells 10 of the conventional grass pavement stone 9 of the present example. For other types of grass pavement stones 9, other arrangements might be reasonable and necessary.

Placing more than one row of positioning-fixing unit 6 on the artificial grass block 1, or, more specifically, on the support 5 of the artificial grass block 1 can be reasonable too.

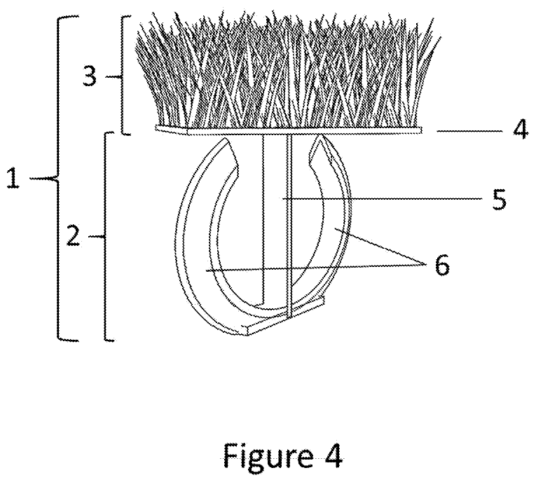

FIG. 4 shows another expedient design. The positioning-fixing unit 6 is circular in this example. The lower part of the circle is attached to the support 5, whereas the outer regions lean to the wall of the cell 10 when the artificial grass block 1 is being inserted into the cell 10 of the grass pavement stone 9. The elastic circular positioning-fixing unit 6 is originally wider than the cell 10 of the grass pavement stone 9, but then squeezed to the cell 10 walls during insertion.

Separating the positioning and fixing functions might be reasonable. In such cases, the positioning and the fixing functions would be carried out by separate parts of the artificial grass block 1.

Another expedient design would be where the positioning-fixing unit 6 could be separated from the rest of the artificial grass block 1 and could be reattached later. Such a positioning-fixing unit 6 would function as effectively as a positioning-fixing unit that cannot be separated from the rest of the artificial grass block 1.

All in all, there are plenty of the possible designs for the positioning-fixing unit 6 those keep its main feature, to accommodate to cells with different sizes, but listing them would take unreasonable efforts and would not ease the understanding of the invention. Therefore, all these possible designs of the positioning-fixing unit 6, which are attached to the scaffold 2 or the holding plate 4 or any other part of the artificial grass block 1 with a permanent or with a temporary bond, and can carry out the function of positioning and fixing the artificial grass block 1 within a minimal and maximal size range of cell 10 of the designated grass pavement stone 9 shall be considered to fall under the scope of the present invention. The fixing should be maintained within the cell 10 of the designated grass pavement stone 9 during reasonable, intended use of the artificial grass block 1 without experiencing any wobbling, moving, turning, or any other movement that would result in the loss of the original function of the artificial grass block 1 whilst being inside of the cell 10.

Inventions published earlier share a common feature, namely that they can only be used together with grass pavement stones of unique designs, or unique cell sizes, which means a constrain to their use and to their spread on the market. Products those are suitable only to highly limited numbers usually to 1 or 2 of grass pavement stones, produced by a specific company, limits the number of reachable costumers too. The market of the grass pavement stones is diverse and large, costumers would not risk buying a product that has a high probability not to be compatible with the pavement stone they own. The artificial grass block of the present invention overcomes this problem by the presence of the positioning-fixing unit that accommodates the artificial grass block to a large number of grass pavement stones.

The use of the grass pavement stones relates to its improved rainwater leaking/draining feature compared to concrete slabs or other paving materials. The artificial grass block when used together with the grass pavement stone can further improve the rainwater leaking/draining feature of the grass pavement stone, as each cell of the grass pavement stone can act as a pool under the holding plate of the artificial grass block.

Each and every part of the artificial grass block can be manufactured by known and used technologies or bought from vendors. The insertion of the artificial grass blocks into the cells of the grass pavement stones does not require extreme strength or qualification, it is a simple and fast work with no requirements for special tools either.

What we claim is:

1. A block with artificial grass (1) to be inserted into and used together with the grass pavement stones (9) comprising:
that the artificial grass block (1) consists of an artificial grass (3) and a scaffold (2), wherein the artificial grass (3) is fixed onto the upper surface of the scaffold (2); and
at least one positioning-fixing unit (6) placed on the scaffold (2), which is designed so that it can appropriately position and firmly fix the artificial grass block (1) inside the cells (10) of similar grass pavement stones (9) produced by different companies, by being able to adopt to the size differences of the cells (10) between a minimal and maximal value those horizontal cross-section are geometrically similar.

2. The artificial grass block (1) according to claim 1, further comprising that the scaffold (2) consists of a holding plate (4) and a support (5) other than the positioning-fixing unit (6), and that the artificial grass (3) is fixed on the top of the holding plate (4), the support (5) stands on the level of foundation (7) and supports the holding plate (4), and the positioning-fixing unit (6) is placed either on the support (5), on the holding plate (4) or on both.

3. The artificial grass block (1) according to claim 1, further comprising that the size of the holding plate (4) shall be defined by considering the smallest reasonable cell (10) size of the grass pavement stones (9) of the same kind, and if inserted into the largest of the cells (10) the resulting gap between the holding plate (4) and the wall of the cell (10) should be covered by the threads of the artificial grass (3) on the holding plate (4).

4. The artificial grass block (1) according to claim 1, further comprising that the height of the artificial grass block (1) standing on the level of foundation (7) in the bottom of the cell (10) should not exceed the maximum level difference resulting between the origin of threads of the artificial grass (3) and the upper surface of the grass pavement stone (9) that is considered to cause the danger of stumble according to safety protection regulations.

5. The artificial grass block (1) according to claim 1, further comprising that the positioning-fixing unit (6) is such a wedge-like, flexible structure, which fixes the artificial grass block (1) in a self-locking manner by a wing-like positioning-fixing unit that bends upwards as the artificial grass block (1) is being inserted into the cell (10) of the grass pavement stone (9), forming an acute angle with the wall of the cell (10), and that is blocked in the irregularities of the concrete surface (11) of the wall of the cell (10), when the artificial grass block (1) is attempted to be removed from the cell (10) locking the artificial grass block (1) inside the cell up to a reasonable amount of force applied.

6. The artificial block (1) according to claims 1 and 5, further comprising that the positioning-fixing unit (6) can have the forms of tubes, corrugated tubes, rods, wires, and other geometries to achieve the self-locking function.

7. The artificial grass block (1) according to claims 1, 5 and 6, further comprising that the positioning-fixing unit points to one of the diagonals of the parallelogram geometry of the horizontal cross-section of the cell (10) of the grass pavement stone (9) and that of the similar shaped holding plate (4) of the artificial grass block (1).

8. The artificial grass block (1) according to claims 1, 5 and 6, further comprising that the positioning-fixing unit points to the sides of the parallelogram geometry of the horizontal cross-section of the cell (10) of the grass pavement stone (9) and that of the similar shaped holding plate (4) of the artificial grass block (1) forming a predefined angle between 45° and 135°, for example 90° with the wall of the cell (10) and with the side of the holding plate (4).

9. The artificial grass block (1) according to claims 1, 5, 6, 7, and 8, further comprising that the positioning-fixing unit (6) can be placed on the scaffold (2) in more than one row and direction.
